(19) United States
(12) Patent Application Publication
(10) Pub. No.: US 2015/0226479 A1
(43) Pub. Date: Aug. 13, 2015

(54) INFRARED HEATING APPARATUS AND DRYING FURNACE

(71) Applicant: NGK Insulators, Ltd., Nagoya-City (JP)

(72) Inventor: Yuuki FUJITA, Nagoya-City (JP)

(21) Appl. No.: 14/691,852

(22) Filed: Apr. 21, 2015

Related U.S. Application Data
(63) Continuation of application No. PCT/JP2013/076644, filed on Oct. 1, 2013.

(30) Foreign Application Priority Data
Nov. 7, 2012 (JP) 2012-245253

(51) Int. Cl. F26B 3/30

(52) U.S. Cl. CPC F26B 3/30

(57) ABSTRACT

When electromagnetic radiation including infrared radiation is emitted from a filament 41, the infrared radiation passes through the inner pipe 42, reaches a reflection layer 46 that is disposed away from the inner pipe 42 so as to cover only a part of a periphery of the filament 41, and is reflected. At this time, the reflection layer 46 is disposed away from the inner pipe 42, and the reflection layer 46 can be cooled by a coolant flowing through a coolant channel 49. Thus, for example, as compared with a case where the reflection layer 46 is formed on the inner pipe 42, overheating of the reflection layer 46 can be further suppressed.

### DESCRIPTION OF THE BACKGROUND ART

1. Field of the Invention

The present invention relates to an infrared heating apparatus and a drying furnace.

2. Description of the Related Art

Infrared heating apparatuses, such as infrared heaters, that emit infrared radiation and that have a heating element enclosed in a pipe, such as a quartz pipe, are known. For example, PTL 1 describes a heater lamp in which a filament, which serves as a heating element, is enclosed in a double-walled pipe that includes a bulb made of quartz glass and an outer pipe. A reflection film is disposed on the outer periphery of the bulb, which is an inner pipe. The heater lamp can efficiently heat an object to be heated, because the reflection film is disposed on a part of the outer periphery of the bulb facing in a direction opposite to a direction of an object to be heated. Moreover, it is described that blackening of the bulb can be suppressed by causing a cooling gas to flow through a space between the bulb and the outer pipe.

### PATENT LITERATURE

PTL 1: Japanese Patent No. 4734885

### SUMMARY OF THE INVENTION

However, in infrared heating apparatuses having the structure described in PTL 1, in which a reflection film is disposed on a surface of an inner pipe of a double-walled pipe, the reflective film may become overheated. Therefore, such apparatuses have a problem in that faults, such as deterioration or peeling of the reflective film, may occur.

The main object of the present invention, which addresses such a problem, is to further suppress overheating of the reflection layer.

An infrared heating apparatus according to the present invention includes

a heating element that emits electromagnetic radiation including infrared radiation when heated;

an inner wall that transmits infrared radiation;

a reflection layer that is disposed outside of the inner wall and away from the inner wall when viewed from the heating element so as to cover only a part of a periphery of the heating element, the reflection layer reflecting infrared radiation; and

a coolant channel that allows a coolant for cooling the reflection layer to flow therethrough.

With the infrared heating apparatus according to the present invention, when electromagnetic radiation including infrared radiation is emitted from a heating element, the infrared radiation passes through the inner wall, reaches the reflection layer that is disposed away from the inner wall so as to cover only a part of the periphery of the heating element, and is reflected. Thus, infrared radiation directly emitted from the heating element and infrared radiation reflected by the reflection layer are emitted to a region that is located on the opposite side to the reflection layer when viewed from the heating element. Therefore, an object to be heated can be efficiently heated. At this time, the reflection layer is disposed away from the inner wall, and the reflection layer can be cooled by a coolant that flows through the coolant channel. Thus, for example, as compared with a case where the reflection layer is formed on the inner wall, overheating of the reflection layer can be further suppressed. The electromagnetic radiation may have, for example, a peak wavelength in the infrared region (wavelength range of 0.7 μm to 8 μm) or the near infrared region (wavelength range of 0.7 μm to 3.5 μm). The shape of the inner wall may be, for example, a pipe that surrounds the heating element or may be a flat plate. The shape of the reflection layer may be, for example, a curved plate having an arc-like cross-sectional shape or a flat plate. The infrared heating apparatus according to the present invention may include flow rate adjusting means for adjusting the amount of coolant that flows through the coolant channel.

The infrared heating apparatus according to the present invention may further include a transmission wall that is disposed between the inner wall and the reflection layer and that transmits infrared radiation. In this case, two layers, which are the inner wall and the transmission wall, are present between the heating element and the reflection layer. Accordingly, overheating of the reflection layer can be further suppressed. The shape of the transmission wall may be, for example, a pipe surrounding the heating element or a flat plate. In the infrared heating apparatus, the reflection layer may be disposed away from the transmission wall. In this case, as compared with a case where the reflection layer is in contact with the transmission wall, overheating of the reflection layer can be further suppressed. The reflection layer may be formed on the surface of the transmission wall, that is, may be in contact with the transmission wall.

The infrared heating apparatus according to the present invention may further include a reflection plate that is disposed outside of the reflection layer when viewed from the heating element so as to cover only a part of the periphery of the heating element, the reflection plate reflecting infrared radiation. In this case, because infrared radiation from the heating element can be reflected by both of the reflection layer and the reflection plate, a larger amount of infrared radiation can be emitted to a region on the opposite side to the reflection layer and the reflection plate when viewed from the heating element, and therefore an object to be heated can be more efficiently heated. The shape of the reflection plate may be, for example, a curved plate having an arc-like cross-sectional shape or a flat plate.

The infrared heating apparatus according to the present invention may further include an outer wall that is disposed outside of the reflection layer and away from the reflection layer when viewed from the heating element, and the coolant channel may be formed inside of the outer wall when viewed from the heating element. The shape of the outer wall may be, for example, a pipe that surrounds the heating element or a flat plate. The outer wall may transmit infrared radiation. In the infrared heating apparatus, the reflection layer may be in contact with the transmission wall or may be disposed between the transmission wall and the outer wall, and the coolant channel may be a space surrounded by the transmission wall and the outer wall. In this case, not only the reflection layer but also the outer wall can be cooled by a coolant that flows through the coolant channel. The reflection layer may be in contact with the transmission wall or disposed between the transmission wall and the inner wall, and the coolant channel may be a space surrounded by the transmission wall and the inner wall.

In the infrared heating apparatus according to the present invention, the inner wall may absorb a part of the electromagnetic radiation. In this case, heat of the reflection layer can be further suppressed. In the infrared heating apparatus, the inner wall may absorb infrared radiation, which is included in the electromagnetic radiation, having a wavelength greater than 3.5 μm. In this case, the proportion of near infrared radiation (for example, electromagnetic radiation in the wavelength range of 0.7 μm to 3.5 μm) emitted from the infrared heating apparatus to the outside is increased. Because near infrared radiation can efficiently break hydrogen bonds in water or a solvent in an object to be heated, the object to be heated can be heated and dried efficiently.

A drying furnace according to the present invention includes any one of the infrared heating apparatuses according to the present invention described above. Therefore, with the drying furnace according to the present invention, advantages the same as those of the infrared heating apparatus according to the present invention, such as further suppression of overheating of the reflection layer, can be obtained.

### BRIEF DESCRIPTION OF THE DRAWINGS

FIG. 1 is a longitudinal sectional view of a drying furnace 10.

FIG. 2 is a longitudinal sectional view of an infrared heater 40.

FIG. 3 is a cross-sectional view taken along line A-A of FIG. 2.

FIG. 4 is a cross-sectional view of an infrared heater according to a modification.

FIG. 5 is a cross-sectional view of an infrared heater according to a modification.

FIG. 6 is a cross-sectional view of an infrared heater 40a according to a modification.

FIG. 7 is a longitudinal sectional view of a drying furnace 110 according to a modification.

FIG. 8 is a cross-sectional view of an infrared heater according to Example 2.

FIG. 9 is a cross-sectional view of an infrared heater according to Comparative Example 2.

### DESCRIPTION OF THE PREFERRED EMBODIMENTS

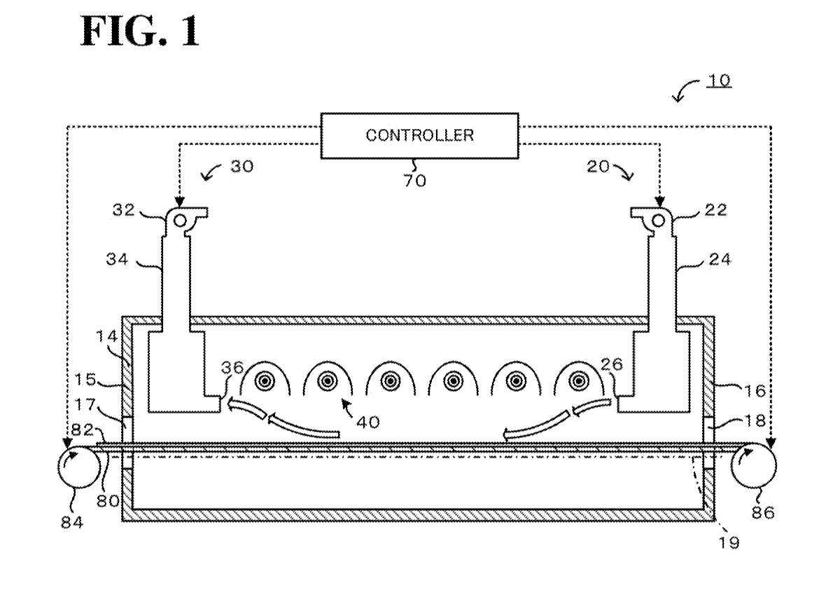

Next, embodiments of the present invention will be described with reference to the drawings. FIG. 1 is a longitudinal sectional view of a drying furnace 10 including infrared heaters 40, each corresponding to an infrared heating apparatus according to the present invention. The drying furnace 10 dries a coating 82, which has been applied to a sheet 80, by using infrared radiation and hot gas. The drying furnace 10 includes a furnace body 14, a conveying path 19, a blowing device 20, a gas exhausting device 30, the infrared heaters 40, and a controller 70. The drying furnace 10 further includes a roller 84, which is disposed on the left side of the furnace body 14, and a roller 86, which is disposed on the right side of the furnace body 14. The drying furnace 10 is a so-called “roll-to-roll drying furnace”. The drying furnace 10 dries the sheet 80, on an upper surface of which the coating 82 to be dried has been formed, while continuously conveying the sheet 80 by using the rollers 84 and 86.

The furnace body 14 is a heat-insulated structure having a substantially rectangular-parallelepiped shape. The furnace body 14 has openings 17 and 18 in a front end surface 15 and a rear end surface 16, respectively. The length of the furnace body 14 from the front end surface 15 to the rear end surface 16 is, for example, in the range of 2 to 10 m.

The conveying path 19 is a path extending from the opening 17 to the opening 18 through the furnace body 14 in the horizontal direction. The sheet 80, on one surface of which the coating 82 has been applied, passes along the conveying path 19. The sheet 80, with the surface having the coating 82 facing up, is conveyed into the furnace body 14 from the opening 17. Then, the sheet 80 is moved in the furnace body 14 in the horizontal direction and is conveyed out of the opening 18.

The blowing device 20 heats and dries the coating 82, which passes through the inside of the furnace body 14, by blowing hot gas. The blowing device 20 includes a hot gas generator 22, a pipe structure 24, and a vent 26. The hot gas generator 22 is attached to the pipe structure 24 and supplies hot gas into the pipe structure 24. The hot gas is, for example, heated air. The hot gas generator 22 is capable of adjusting the amount and the temperature of hot gas to be generated. The amount of hot gas, which is not particularly limited, can be adjusted in the range of, for example, 100 Nm³/h to 2000 Nm³/h. The temperature of hot gas, which is not particularly limited, can be adjusted in the range of, for example, 40 to 400° C. The pipe structure 24 serves as a path of hot gas from the hot gas generator 22. The pipe structure 24 forms a path extending from the hot gas generator 22, through a top panel of the furnace body 14, and to the inside of the furnace body 14. The vent 26 serves as an inlet through which hot gas is supplied from the hot gas generator 22. The vent 26 is disposed at an end portion of the furnace body 14 near the opening 18, through which the sheet 80 is conveyed out of the furnace body 14. The vent 26 has an opening that faces the opening 17, through which the sheet 80 is conveyed into the furnace body 14, in the horizontal direction. Thus, the blowing device 20 supplies hot gas in a direction (leftward in FIG. 1) in which the sheet 80 is conveyed into and out of the furnace body 14. As indicated by arrows in the furnace body 14 of FIG. 1, hot gas flows along the upper surface of the sheet 80 and heats the upper surface of the sheet 80.

The gas exhausting device 30 is a device for discharging atmospheric gas in the furnace body 14. The gas exhausting device 30 includes a blower 32, a pipe structure 34, and an exhaust hole 36. The exhaust hole 36 serves as an outlet through which the atmospheric gas (mainly hot gas that has been used to dry the coating 82) in the furnace body 14 is discharged. The exhaust hole 36 is disposed at an end portion of in the furnace body 14 near the opening 17, through which the sheet 80 is conveyed into the furnace body 14. The outlet has an opening that faces the opening 18, through which the sheet 80 is conveyed out of the furnace body 14, in the horizontal direction. The exhaust hole 36 is attached to the pipe structure 34. Atmospheric gas in the furnace body 14 is drawn into the pipe structure 34 through the exhaust hole 36. The pipe structure 34 serves as a channel of atmospheric gas from the exhaust hole 36 to the blower 32. The pipe structure 34 forms a path extending from the exhaust hole 36, through the top panel of the furnace body 14, and to the blower 32 outside of the furnace body 14. The blower 32 is attached to the pipe structure 34 and discharges atmospheric gas in the pipe structure 34. The blower 32 is connected to, for example, gas-exhaust piping (not shown). After performing appropriate treatments, such as removal of an organic solvent or the like evaporated from the coating 82 from the atmospheric gas in the furnace body 14, the blower 32 discharges the atmospheric gas to the outside of the drying furnace 10. Instead of discharging the atmospheric gas in the pipe structure 34 to the outside of the drying furnace 10, the blower 32 may circulate the atmospheric gas as intake air of the hot gas generator 22.

The infrared heaters 40 are devices for irradiating the coating 82, which passes through the inside of the furnace body 14, with near infrared radiation. The infrared heaters 40 are disposed near the top panel of the furnace body 14. In the present embodiment, six infrared heaters 40 are arranged from the front end surface 15 side to the rear end surface 16 side at substantially regular intervals. The infrared heaters 40 have the same structure and are disposed so that the longitudinal direction thereof is perpendicular to the conveying direction.

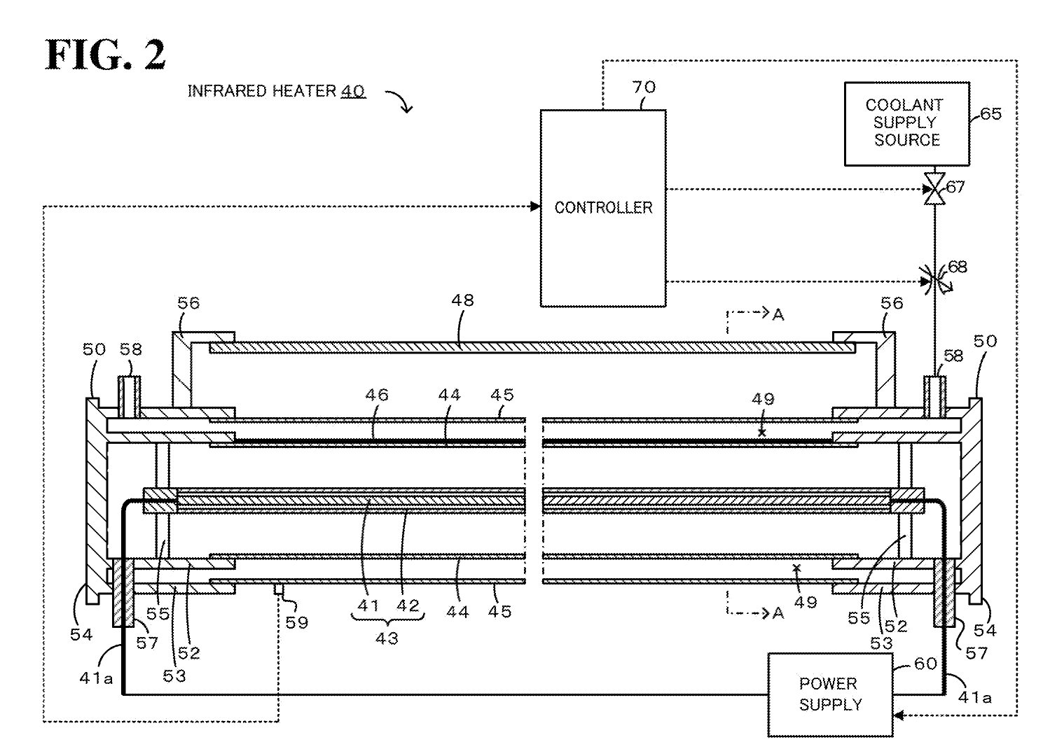

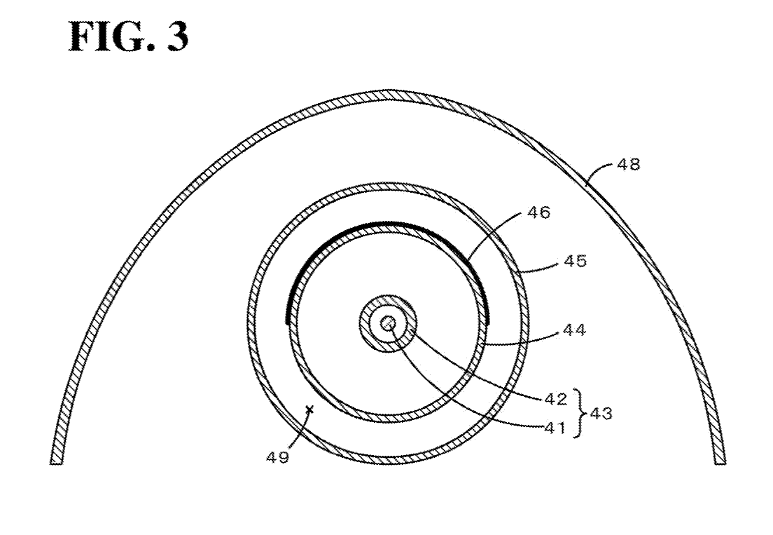

FIG. 2 is a longitudinal sectional view of the infrared heater 40. FIG. 3 is a cross-sectional view taken along line A-A of FIG. 2. The sectional surface shown in FIG. 2 is taken along a plane passing through the center line of a heater body 43. As illustrated in these figures, the infrared heater 40 includes the heater body 43, a first outer pipe 44, a second outer pipe 45, and a reflection plate 48. The heater body 43 includes a filament 41 made of tungsten and an inner pipe 42 surrounding the filament 41. The first outer pipe 44 is disposed outside of the heater body 43 so as to surround the inner pipe 42. The second outer pipe 45 is disposed outside of the first outer pipe 44 so as to surround the first outer pipe 44. The reflection plate 48 is disposed above the second outer pipe 45. Caps 50 are attached to both ends of each of these. A space between the first outer pipe 44 and the second outer pipe 45 is a coolant channel 49 that allows a coolant (such as air) to flow therethrough. The infrared heater 40 includes a temperature sensor 59 for detecting the surface temperature of the second outer pipe 45. The inner pipe 42, the first outer pipe 44, and the second outer pipe 45 are disposed concentrically, and the filament 41 is disposed at the center of the circles.

Both ends of the heater body 43 are supported by holders 55, which are disposed in the caps 50. The heater body 43 emits electromagnetic radiation including infrared radiation, when electric power is supplied from a power supply 60 to the filament 41 and the filament 41 is heated to a predetermined temperature (for example, a temperature in the range of 1200 to 1500° C.). Electromagnetic radiation emitted by the filament 41 is not particularly limited. For example, the electromagnetic radiation has a peak wavelength in the infrared region (wavelength range of 0.7 μm to 8 μm) or the near infrared region (wavelength range of 0.7 μm to 3.5 μm). In the present embodiment, the filament 41 emits electromagnetic radiation having a peak wavelength of about 3 μm. The inner pipe 42 is a pipe that has a circular cross section and that surrounds the filament 41. The inner pipe 42 is made of an infrared transmitting material that absorbs a part of electromagnetic radiation emitted from the filament 41 and that transmits infrared radiation. Examples of such an infrared transmitting material used for the inner pipe 42 include germanium, silicon, sapphire, calcium fluoride, barium fluoride, zinc selenide, zinc sulfide, chalcogenide glass, transmissive alumina ceramic, and quartz glass that can transmit infrared radiation. In the present embodiment, the inner pipe 42 is made of a quartz glass, which is one of the aforementioned infrared transmitting materials. The quartz glass absorbs infrared radiation, which is a part of the electromagnetic radiation, having a wavelength greater than 3.5 μm and transmits infrared radiation having a wavelength of 3.5 μm or less. The inside of the inner pipe 42 is a vacuum atmosphere or a halogen atmosphere. Electric wiring 41a is connected to the filament 41. The electric wiring 41a is drawn out to the outside through a wiring conduit 57, which is airtight and is connected to the power supply 60.

The first outer pipe 44 and the second outer pipe 45 are each made of one of the aforementioned infrared transmitting materials. In the present embodiment, as with the inner pipe 42, the first outer pipe 44 and the second outer pipe 45 are each made of a quartz glass that absorbs infrared radiation having a wavelength greater than 3.5 μm and that transmits infrared radiation having a wavelength of 3.5 μm or less. The first outer pipe 44 and the second outer pipe 45 can be cooled to a temperature of, for example, 200° C. or lower by a coolant that flows through the coolant channel 49.

A reflection layer 46 is formed on an outer surface of the first outer pipe 44. The reflection layer 46 is disposed outside of the inner pipe 42 and away from the inner pipe 42 when viewed from the filament 41 so as to cover only a part of the periphery of the filament 41. To be more specific, the reflection layer 46 is formed on an upper part of the outer surface of the first outer pipe 44 in FIGS. 2 and 3, that is, on the opposite side to the coating 82, which is an object to be heated, when viewed from the filament 41 and covers the entirety of an upper half of the first outer pipe 44. The reflection layer 46 is made of an infrared radiation reflecting material that reflects at least infrared radiation included in the electromagnetic radiation emitted from the filament 41. Examples of the infrared radiation reflecting material include gold, platinum, and aluminum. The reflection layer 46 is formed by applying an infrared radiation reflecting material to the surface of the first outer pipe 44 by using a film-forming method, such as application and drying, sputtering, CVD, or flame spraying. The reflection layer 46 is disposed so that the filament 41 is located at the center of a circle including the arc of a cross-section of the reflection layer 46. As a result, a part of infrared radiation emitted from the filament 41 is reflected by the reflection layer 46, and the coating 82 is efficiently irradiated with infrared radiation. The reflection layer 46, which faces the coolant channel 49, is cooled by a coolant that flows through the coolant channel 49.

The reflection plate 48 is a plate-shaped member that is formed outside of the reflection layer 46 when viewed from the filament 41 so as to cover only a part of the periphery of the filament 41. To be more specific, the reflection plate 48 is disposed in the furnace body 14 so as to cover the second outer pipe 45 from above in FIGS. 2 and 3. The reflection plate 48 is made of a material that reflects at least infrared radiation included in the electromagnetic radiation emitted from the filament 41. Examples of the material of the reflection plate 48 include metals, such as SUS304 and aluminum. As with the inner pipe 42, the first outer pipe 44, and the second outer pipe 45, the reflection plate 48 is formed so as to extend in a direction perpendicular to the conveying direction of the coating 82. The cross-sectional shape of the reflection plate 48 is a curve, such as a parabola, an elliptic arc, an arc, or the like. The infrared heater 40 (filament 41) is disposed at the focus or the center of the curve. As a result, a part of infrared radiation emitted from the filament 41 is reflected by the reflection plate 48, and the coating 82 is efficiently irradiated with infrared radiation.

As illustrated in FIG. 2, the caps 50 each include a cover 54, which is disk-shaped, and two cylindrical portions 52 and 53, which stand on the cover 54 and are integrally formed with the cover 54. The cylindrical portions 52 and 53 are concentric to each other and have different diameters. The left and right ends of the first outer pipe 44 are fixed to the cylindrical portion 52, which is located inside. The left and right ends of the second outer pipe 45 are fixed to the cylindrical portion 53, which is located outside. Attachment members 56 are disposed on both end portions of upper parts of the caps 50. The reflection plate 48 is fixed in place by using the attachment member 56.

The coolant channel 49 is a space between the first outer pipe 44 and the second outer pipe 45. A coolant can flow through fluid inlet/outlet ports 58 formed in the cap 50 and through the coolant channel 49. The coolant flowing through the coolant channel 49 serves to decrease the temperature of the second outer pipe 45, which forms an outer surface of the infrared heater 40, and the temperatures of the first outer pipe 44 and the reflection layer 46.

The controller 70 is a microprocessor having a CPU as its core. The controller 70 independently controls the temperature and the amount of hot gas generated by the hot gas generator 22 of the blowing device 20 by outputting a control signal to the hot gas generator 22. The controller 70 independently controls the flow rate of a coolant that flows through the coolant channel 49 of each of the infrared heaters 40 by inputting the temperatures of the second outer pipe 45 detected by the temperature sensor 59, each of which is a thermocouple, and by outputting a control signal to an on-off valve 67 and a flow control valve 68, which are disposed in piping that connects a coolant supply source 65 to the fluid inlet/outlet ports 58. Moreover, the controller 70 independently controls the filament temperature of each of the infrared heaters 40 by outputting, to the power supply 60, a control signal for adjusting the amount of electric power supplied from the power supply 60 to the filament 41. The controller 70 can adjust the time required by the coating 82 to pass through the inside of the furnace body 14 by controlling the rotation speeds of the rollers 84 and 86.

The sheet 80, which is not particularly limited, is, for example, a metal sheet, such as an aluminum sheet or a copper sheet. After having been dried, the coating 82 on the sheet 80 is used, for example, as an electrode of a battery. Although it is not particularly limited, the coating is used, for example, as an electrode of a lithium-ion secondary battery. Examples of the coating 82 include a coating formed by applying, onto the sheet 80, an electrode material paste in which an electrode material (a cathode active material or an anode active material), a binder, a conductive material, and a solvent are mixed with each other. Examples of the electrode material as a cathode active material include lithium cobaltite. Examples of the electrode material as an anode active material include a carbon material, such as graphite. Examples of the binder include polyvinylidene fluoride (PVDF). Examples of the conductive material include carbon powder. Examples of the solvent include N-methyl-2-pyrrolidone (NMP). The thickness of the coating 82, which is not particularly limited, is in the range of, for example, 20 to 1000 μm.

Next, the process of drying the coating 82 by using the drying furnace 10, having the above structure, will be described. First, referring to FIG. 1, the sheet 80 is unwound from the roller 84, which is disposed at the left end of the drying furnace 10; a coater (not shown) applies the coating 82 to the upper surface of the sheet 80 before the sheet 80 is conveyed into the furnace body 14 of the drying furnace 10; and the sheet 80 is conveyed into the furnace body 14 through the opening 17 into the furnace body 14. Next, while the sheet 80 passes through the inside of the furnace body 14, the blowing device 20 and the infrared heater 40 heats the sheet 80, so that the solvent evaporates from the coating 82. The solvent that has evaporated from the coating 82 due to heat is discharged to the outside by the blower 32 through the exhaust hole 36. Finally, the coating 82 is conveyed to the outside through the opening 18 of the furnace body 14 and wound around the roller 86, which is disposed at the right end of the drying furnace 10, together with the sheet 80. The solvent evaporates from the coating 82 due to the function of infrared radiation emitted from the infrared heater 40 and the function of hot gas supplied by the blowing device 20.

An operation that is performed by the infrared heater 40 when drying the coating 82 in this way will be described in detail. The filament 41 of the infrared heater 40 emits electromagnetic radiation having a peak wavelength of about 3 μm. A part of the electromagnetic radiation having a wavelength greater than 3.5 μm is absorbed by the inner pipe 42, the first outer pipe 44, and the second outer pipe 45. Mainly, infrared radiation having a wavelength of 3.5 μm or less passes through the inner pipe 42, the first outer pipe 44, and the second outer pipe 45 to the outside of the second outer pipe 45. The coating 82 on the sheet 80, which passes along the conveying path 19, is irradiated with the infrared radiation. Infrared radiation having such a wavelength, which is said to have high ability in breaking hydrogen bonds of a solvent included in the coating 82 on the sheet 80, can efficiently evaporate the solvent. When viewed from the filament 41, the reflection layer 46 and the reflection plate 48 are disposed on the opposite side to the coating 82. Therefore, infrared radiation included in the electromagnetic radiation that is emitted from the filament 41 to the opposite side to the coating 82 is reflected by the reflection layer 46 and the reflection plate 48. As a result, the coating 82 is irradiated with infrared radiation that is directly emitted from the filament 41 and infrared radiation reflected by the reflection layer 46 and the reflection plate 48. Accordingly, the object to be heated (coating 82) can be efficiently heated. The first outer pipe 44 and the second outer pipe 45, which absorb infrared radiation having a wavelength greater than 3.5 μm, is cooled by a coolant that flows through the coolant channel 49. In the present embodiment, the controller 70 controls the flow rate of the coolant in the coolant channel 49, so that the temperature of the second outer pipe 45 can be maintained to be lower than the ignition temperature of a solvent evaporating from the coating 82 (for example, 200° C. or lower).

The reflection layer 46 is formed on the first outer pipe 44, which is away from the inner pipe 42 nearest to the filament 41. Moreover, the reflection layer 46 is cooled by a coolant that flows through the coolant channel 49. Thus, for example, as compared with a case where the reflection layer 46 is formed on the surface of the inner pipe 42, overheating of the reflection layer 46 is further suppressed. Accordingly, faults, such as peeling or degradation of the reflection layer 46, can be further suppressed. Moreover, the inner pipe 42 absorbs electromagnetic radiation having a wavelength greater than 3.5 μm. Therefore, the inner pipe 42 transmits near infrared radiation having a wavelength of 3.5 μm or less while reducing the amount of energy that reaches the reflection layer 46 and suppressing overheating of the reflection layer 46. Accordingly, the coating 82 can be efficiently dried. Furthermore, the reflection layer 46 is disposed between the reflection plate 48 and the filament 41. Therefore, the amount of electromagnetic radiation that reaches the reflection plate 48 can be reduced by using the reflection layer 46, and overheating of the reflection plate 48 can be also suppressed. As described above, the infrared heater 40 according to the present embodiment can efficiently dry the coating 82 while suppressing overheating of the reflection layer 46 and the reflection plate 48.

Here, the correspondences between the elements of the present embodiment and the elements according to the present invention will be described. The filament 41 of the present embodiment corresponds to heating element according to the present invention, the inner pipe 42 corresponds to an inner wall, the reflection layer 46 corresponds to a reflection layer, the coolant channel 49 corresponds to a coolant channel, the first outer pipe 44 corresponds to a transmission wall, the reflection plate 48 corresponds to a reflection plate, and the second outer pipe 45 corresponds to an outer wall. In the present embodiment, an example of a drying furnace according to the present invention is also described as a result of describing the drying furnace 10 including the infrared heater 40.

With the infrared heater 40 according to the present embodiment described above, when electromagnetic radiation including infrared radiation is emitted from the filament 41, the infrared radiation passes through the inner pipe 42 and reaches the reflection layer 46, which is disposed away from the inner pipe 42 so as to cover only a part of the periphery of the filament 41, and is reflected by the reflection layer 46. Thus, infrared radiation directly emitted from the filament 41 and infrared radiation reflected by the reflection layer 46 are emitted to a region located on the opposite side to the reflection layer 46 when viewed from the filament 41 (in FIGS. 1 to 3, a region below the infrared heater 40). Therefore, the coating 82, which is an object to be heated, can be efficiently heated. At this time, the reflection layer 46 is disposed away from the inner pipe 42, and the reflection layer 46 can be cooled by a coolant that flows through the coolant channel 49. Thus, for example, as compared with a case where the reflection layer 46 is formed on the inner pipe 42, overheating of the reflection layer 46 can be further suppressed.

The first outer pipe 44, which transmits infrared radiation, is disposed between the inner pipe 42 and the reflection layer 46. Thus, two layers, which are the inner pipe 42 and the first outer pipe 44, are present between the filament 41 and the reflection layer 46. Accordingly, overheating of the reflection layer 46 can be further suppressed.

Moreover, the reflection plate 48, which reflects infrared radiation, is disposed outside of the reflection layer 46 when viewed from the filament 41 so as to cover only a part of the outer periphery of the filament. Thus, infrared radiation from the filament 41 can be reflected by both of the reflection layer 46 and the reflection plate 48. Therefore, a larger amount of infrared radiation can be emitted to a region on the opposite side to the reflection layer 46 and the reflection plate 48 when viewed from the filament 41. Accordingly, an object to be heated (coating 82) can be more efficiently heated.

Moreover, the second outer pipe 45, which is disposed outside of the reflection layer 46 and away from the reflection layer 46 when viewed from the filament 41, is provided, and the coolant channel 49 is a space surrounded by the first outer pipe 44 and the second outer pipe 45. Thus, not only the reflection layer 46 but also the second outer pipe 45 can be cooled by a coolant that flows through the coolant channel 49. The amount of infrared radiation that reaches an exposed surface of the infrared heater 40 exposed to the outside (the outer surface of the second outer pipe 45) can be reduced by using the reflection layer 46. Also for this reason, overheating of the exposed surface can be suppressed.

Furthermore, because the inner pipe 42 absorbs a part of electromagnetic radiation from the filament 41, overheating of the reflection layer 46 can be further suppressed. Moreover, because the inner pipe 42 absorbs infrared radiation having a wavelength greater than 3.5 μm, the proportion of near infrared radiation emitted from the infrared heater 40 to the outside is increased, and heating or drying of the coating 82 can be efficiently performed.

Note that the present invention is not limited to the embodiment described above, and it is needless to say that the present invention can be implemented in various ways within the technical scope thereof.

For example, in the embodiment described above, the inner pipe 42, the first outer pipe 44, and the second outer pipe 45 are each made of a quartz glass that absorbs infrared radiation having a wavelength greater than 3.5 μm, which is a part of electromagnetic radiation, and transmits infrared radiation having a wavelength of 3.5 μm or less. However, this is not a limitation, and these pipes may be made of any material that transmits infrared radiation. For example, the inner pipe 42, the first outer pipe 44, and the second outer pipe 45 each may be made of a material that absorbs electromagnetic radiation only negligibly. Alternatively, these members may be made of a material that absorbs electromagnetic radiation that is emitted from the filament 41 and that has a wavelength outside the wavelength range of electromagnetic radiation with which an object to be heated can be efficiently heated and dried. However, preferably, the inner pipe 42 absorbs a part of electromagnetic radiation so that overheating of the reflection layer 46 can be further suppressed. Preferably, when the first outer pipe 44 is disposed between the reflection layer 46 and the filament 41, the first outer pipe 44 absorbs a part of electromagnetic radiation as the inner pipe 42 does. It is not necessary that the materials of the inner pipe 42, the first outer pipe 44, and the second outer pipe 45 be the same. One or more of these may be made of different materials.

In the embodiment described above, the infrared heater 40 includes the reflection plate 48. However, this may be omitted. In this case, a reflection plate may be attached to a part of the furnace body 14 near the top panel.

In the embodiment described above, the coolant channel 49 is a space between the first outer pipe 44 and the second outer pipe 45. However, this is not a limitation, as long as the coolant channel can cool the reflection layer 46 by allowing a coolant to flow therethrough. A coolant that flows through a coolant channel may indirectly cool the reflection layer 46. For example, a space between the inner pipe 42 and the first outer pipe 44 may be used as a coolant channel, and the reflection layer 46 may be cooled via the first outer pipe 44.

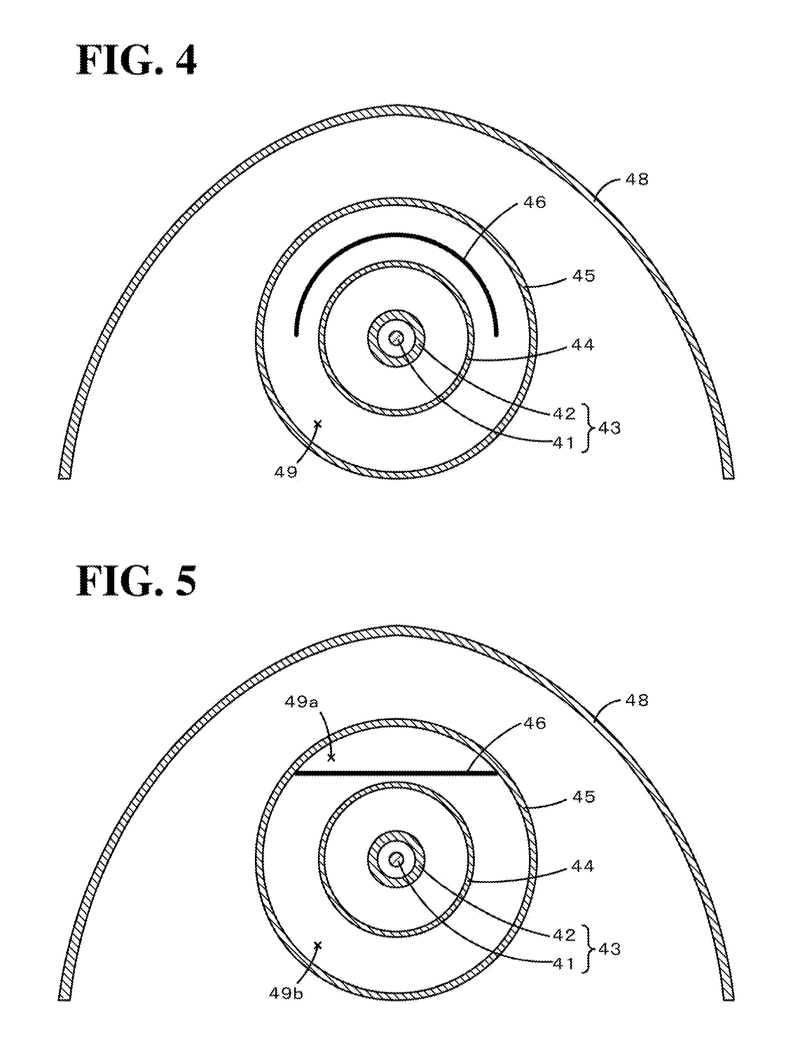

In the embodiment described above, the reflection layer 46 is formed on the outer surface of the first outer pipe 44. However, this is not a limitation, as long as the reflection layer 46 is formed away from the inner pipe 42. For example, the reflection layer 46 may be formed on the inner surface of the first outer pipe 44. In this case, a coolant that flows through the coolant channel 49 may indirectly cool the reflection layer 46 via the first outer pipe 44. Alternatively, a space between the first outer pipe 44 and the inner pipe 42 may be used as the coolant channel, and the reflection layer 46 may be cooled by using a coolant that flows through the coolant channel. Further alternatively, as illustrated in FIG. 4, the reflection layer 46 may be formed as an independent layer that is located away from the first outer pipe 44. By disposing the reflection layer 46 outside of the first outer pipe 44 and away from the first outer pipe 44, the effect of suppressing overheating of the reflection layer 46 is increased. In this case, the reflection layer 46 may be supported, for example, by the caps 50 from both ends of the infrared heater in the longitudinal direction. The reflection layer 46 may be formed on the outer surface or the inner surface of the second outer pipe 45. Preferably, however, in order that overheating of the second outer pipe 45 can be suppressed, the reflection layer 46 is formed between the filament 41 and the second outer pipe 45 and away from the second outer pipe 45.

In the embodiment described above, the reflection layer 46 has a semicircular cross-sectional shape and covers the entirety of an upper half of the first outer pipe 44. However, this is not a limitation, as long as the reflection layer 46 covers only a part of the periphery of the filament 41. For example, the reflection layer 46 may have an arc-shaped cross section having an acute center angle and may cover a part of an upper half of the first outer pipe 44. Alternatively, for example, the reflection layer 46 may have an arc-shaped cross section having a center angle greater than 180° and may cover not only an upper half of but also a part of a lower half of the first outer pipe 44.

In the embodiment described above, the reflection layer 46 has an arc-shaped cross section. However, this is not a limitation. For example, the cross section may be a curve, such as a parabola or an elliptic arc. In this case, the filament 41 may be disposed at the focus or the center of the cross-sectional shape of the reflection layer 46. As illustrated in FIG. 5, the cross section of the reflection layer 46 may be linear, that is, the reflection layer 46 may have a flat plate-like shape. In this case, a space 49a between the reflection layer 46 and the second outer pipe 45 may be used as a coolant channel, or a space 49b between the reflection layer 46 and the first outer pipe 44 may be used as a coolant channel. Both of the spaces 49a and 49b may be used as coolant channels.

In the embodiment described above, the infrared heater 40 includes three pipes, which are the inner pipe 42, the first outer pipe 44, and the second outer pipe 45. However, the infrared heater 40 may include four or more pipes, or need not include at least one of the first outer pipe 44 and the second outer pipe 45. In the case where the infrared heater 40 does not include the second outer pipe 45, a space surrounded by the first outer pipe 44 and the inner pipe 42 may be used as a coolant channel.

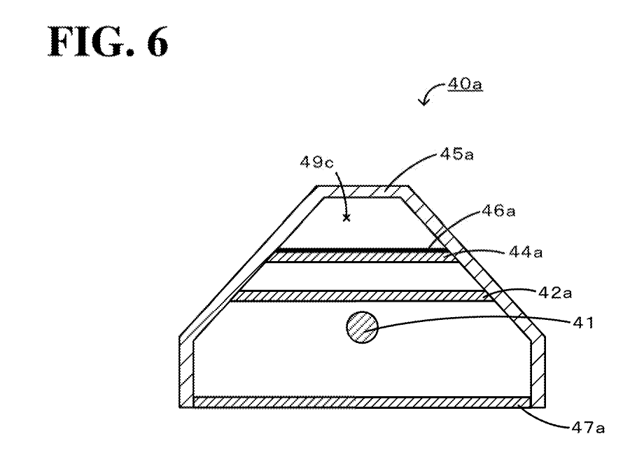

In the embodiment described above, the infrared heater 40 includes three pipes, which are the inner pipe 42, the first outer pipe 44, and the second outer pipe 45. However, the infrared heater 40 may have a different structure. For example, instead of the inner pipe 42, a flat plate-shaped inner wall that transmits infrared radiation may be disposed between the filament 41 and the reflection layer 46. Instead of the first outer pipe 44, a flat plate-shaped transmission wall that transmits infrared radiation may be disposed between the inner pipe 42 and the reflection layer 46. Alternatively, instead of the second outer pipe 45, a curved plate-shaped outer wall may be disposed outside of the reflection layer 46 and away from the reflection layer 46 when viewed from the filament 41 so as to cover the side surface or the upper surface of the filament 41. For example, the structure of the infrared heater may the same as that of an infrared heater 40a according a modification, which is illustrated in FIG. 6. The infrared heater 40a includes an outer wall 45a; and a filament 41, an inner wall 42a, a transmission wall 44a, a reflection layer 46a, and an infrared transmitting plate 47a, which are disposed in the outer wall 45a. The outer wall 45a has a hexagonal cross-sectional shape whose bottom side is open. The inner wall 42a is a flat plate-shaped member disposed above the filament 41 in the outer wall 45a. The transmission wall 44a is a flat plate-shaped member that is disposed outside of the inner wall 42a and away from the inner wall 42a when viewed from the filament 41. As with the reflection layer 46 described above, the reflection layer 46a, which is made of an infrared radiation reflecting material, is formed on the upper surface of the transmission wall 44a and covers the transmission wall 44a. The infrared transmitting plate 47a is a flat plate-shaped member that is located on the opposite side to the reflection layer 46a when viewed from the filament 41 and that is disposed so as to cover the bottom side of the outer well 45a, which is open. Each of the inner wall 42a, the transmission wall 44a, and the infrared transmitting plate 47a, which transmits infrared radiation, is made of one of the aforementioned infrared transmitting materials, such as quartz glass. A space 49c surrounded by the upper side of the transmission wall 44a and the outer wall 45a is a coolant channel that allows a coolant to flow therethrough. With the infrared heater 40a having such a structure, infrared radiation that is directly emitted from the filament 41 and infrared radiation reflected by the reflection layer 46a pass through the infrared transmitting plate 47a and are emitted to a region below the infrared heater 40a. Therefore, the infrared heater 40a can efficiently heat an object to be heated disposed in the region below the infrared heater 40a. The reflection layer 46a is formed on the transmission wall 44a, which is located away from the inner wall 42a that is directly irradiated with electromagnetic radiation from the filament 41, and the reflection layer 46a is cooled by the coolant that flows through the space 49c. Thus, as with the embodiment described above, overheating of the reflection layer 46a can be further suppressed. The outer wall 45a may or may not transmit infrared radiation. Preferably, as with the reflection plate 48 described above, the outer wall 45a is made of a material that transmits infrared radiation, so that infrared radiation can be efficiently emitted toward a region below the infrared heater 40a. In this case, the outer wall 45a corresponds to an outer wall and a reflection plate according to the present invention.

In the embodiment described above, as illustrated in FIG. 2, a space in which the reflection layer 46 is disposed and a space in which the inner pipe 42 is disposed are separated from each other by the first outer pipe 44 and the caps 50. However, these spaces need not be separated from each other. However, preferably, these spaces are separated from each other so that heat transfer from the inner pipe 42 to the reflection layer 46 can be further suppressed.

In the embodiment described above, W (tungsten) is used as an example of the material of the filament 41, which corresponds to a heating element. However, the material is not particularly limited, as long as the material can emit electromagnetic radiation including infrared radiation when heated. For example, Mo, Ta, an Fe—Cr—Al alloy, and a Ni—Cr alloy may be used.

In the embodiment described above, the infrared heater 40 heats and dries the coating 82, which is to be used as an electrode of a lithium-ion secondary battery. However, an object to be heated is not limited to this.

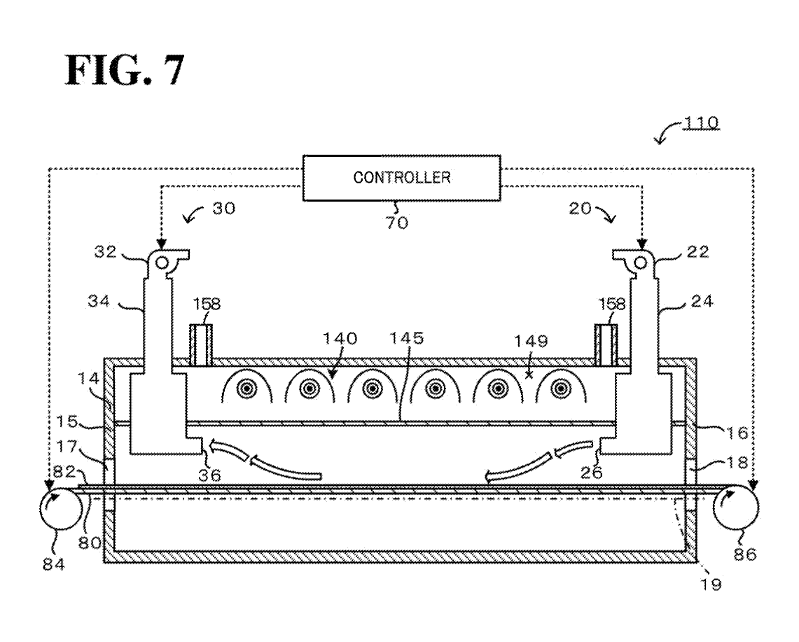

In the embodiment described above, an infrared heating apparatus according to the present invention is embodied in the infrared heater 40. However, this is not a limitation. For example, an infrared heating apparatus according to the present invention may be a drying furnace 110 illustrated in FIG. 7. The drying furnace 110 includes infrared heaters 140, instead of the infrared heaters 40. Although not illustrated, each of the infrared heaters 140 does not include the second outer pipe 45 and the coolant channel 49, which are included in the infrared heater 40. The drying furnace 110 includes an infrared transmitting plate 145, which is disposed in the furnace body 14 so as to spatially separate the infrared heaters 140 from the coating 82. The material of the infrared transmitting plate 145 may be any material that transmits infrared radiation. Any of the aforementioned infrared transmitting materials may be used. Fluid inlet/outlet ports 158 are respectively disposed on parts of the top panel of the furnace body 14 on the front end surface 15 side and on the rear end surface 16 side. Thus, in the drying furnace 110, a space 149, which is surrounded by the furnace body 14 and the infrared transmitting plate 145 and in which the infrared heaters 140 are present, is used as a coolant channel, and a coolant can flow through the space 149. Therefore, the first outer pipe 44, the reflection layer 46, and the reflection plate 48 are cooled by the coolant that flows through the space 149. With the drying furnace 110 having such a structure, the reflection layer 46 is formed away from the inner pipe 42 and the reflection layer 46 can be cooled by a coolant that flows through the space 149. Therefore, as with the present embodiment, overheating of the reflection layer 46 can be further suppressed. The drying furnace 110 corresponds to an infrared heating apparatus according to the present invention, a wall portion of the furnace body 14 corresponds to an outer wall according to the present invention, and the space 149 corresponds to a coolant channel according to the present invention.

In the embodiment described above, air is used as a coolant that flows through the coolant channel. However, an inert gas, such as nitrogen, may be used as a coolant.

### EXAMPLES

### Example 1

The infrared heater 40 having the structure illustrated in FIGS. 1 to 3 was used as Example 1. The outside diameter of the filament 41 of the heater body 43 was 2 ram, the material of the filament 41 was tungsten, and the length of a heat-generating portion of the filament 41 was 600 nm. The material of the inner pipe 42, the first outer pipe 44, and the second outer pipe 45 was quartz glass. The material of the reflection layer 46 was gold, and the thickness of the reflection layer 46 was 5 μm. The material of the reflection plate 48 was SUS304.

### Example 2

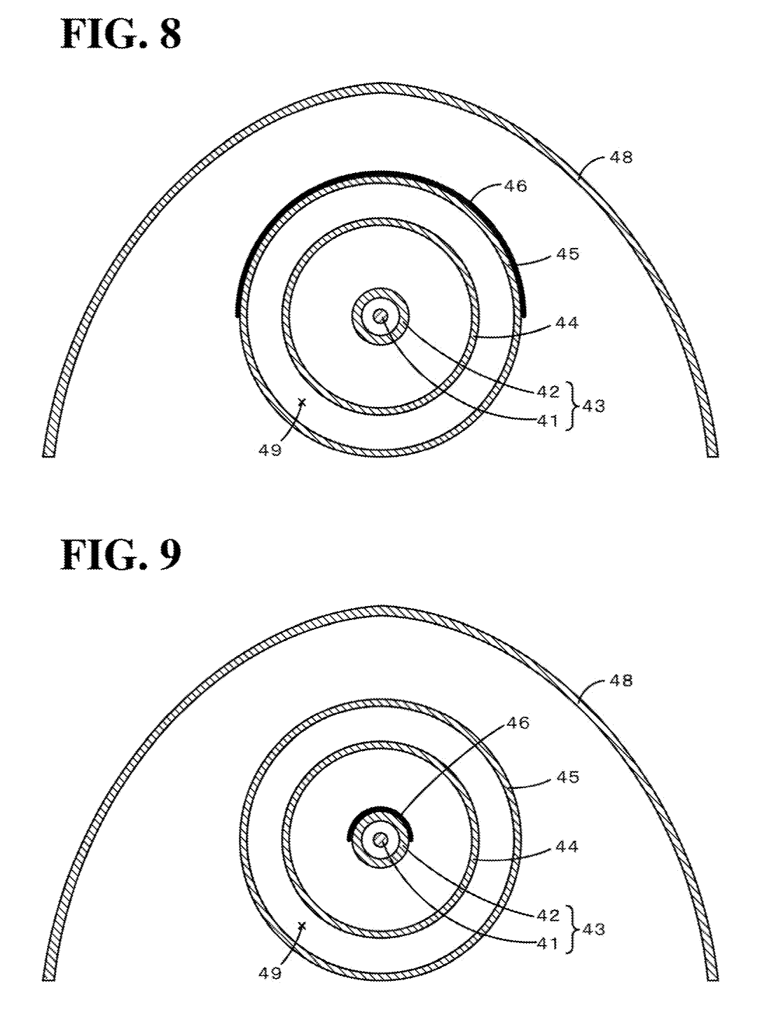

As illustrated in FIG. 8, an infrared heater having the same structure as the infrared heater 40 according to Example 1, except that the reflection layer 46 was formed not on the outer surface of the first outer pipe 44 but on the outer surface of the second outer pipe 45 and the reflection layer 46 covered an upper half of the second outer pipe 45, was used as Example 2.

### Comparative Example 1

An infrared heater having the same structure as the infrared heater 40 of Example 1, except that the first outer pipe 44 did not include the reflection layer 46, was used as Comparative Example 1.

### Comparative Example 2

As illustrated in FIG. 9, an infrared heater having the same structure as the infrared heater 40 of Example 1, except that the reflection layer 46 was formed not on the outer surface of the first outer pipe 44 but on the outer surface of the inner pipe 42 and the reflection layer 46 covered an upper half of the inner pipe 42, was used as Comparative Example 2.

Evaluation Test

In each of the infrared heaters of Examples 1 and 2 and Comparative Examples 1 and 2, the temperature of the filament 41 was increased to 1000° C., and the flow rate of air through the coolant channel 49 was set at 100 L/min. After two hours, the temperatures of the reflection plate 48, the upper end of the second outer pipe 45 (an end on the reflection plate 48 side when viewed from the filament 41), the lower end of the second outer pipe 45 (an end on the opposite side to the reflection plate 48 when viewed from the filament 41) were measured. Moreover, whether or not peeling of the reflection layer 46 occurred was examined. The results are shown in Table 1. Regarding Comparative Example 2, temperature was not measured.

TABLE 1

| | | | | Comparative | Comparative |
|---|---|---|---|---|---|
| | | Example 1 | Example 2 | Example 1 | Example 2 |
| Temperature | Reflection Plate | 90 | 90 | 150 | — |
| (° C.) | | | | | |
| | Upper End | 80 | 190 | 120 | — |
| | of Second | | | | |
| | Outer Pipe | | | | |
| | Lower End | 125 | 125 | 120 | — |
| | of Second | | | | |
| | Outer Pipe | | | | |

| | | | | |
|---|---|---|---|---|
| Peeling of Reflection Layer | Not occurred | Not occurred | — | Occurred |

As can be seen from Table 1, peeling of the reflection layer 46 was not observed in Examples 1 and 2. In contrast, peeling of the reflection layer 46 was observed in Comparative Example 2. It is considered that, because the reflection layer 46 was located away from the inner pipe 42 and the reflection layer 46 was cooled by air flowing through the coolant channel 49 in Examples 1 and 2, overheating of the reflection layer 46 could be suppressed and peeling did not occur as a result.

The temperature of the reflection plate 48 of each of Examples 1 and 2 was lower than that of Comparative Example 1. It is considered that, because the reflection layer 46 was provided in Examples 1 and 2, the amount of electromagnetic radiation that reached the reflection plate 48 could be reduced and overheating of the reflection plate 48 could be suppressed. The temperature of the lower end of the second outer pipe 45 of each of Examples 1 and 2 was slightly higher than that of Comparative Example 1. It is considered that, because the reflection layer 46 was provided in Examples 1 and 2 and therefore infrared radiation was reflected not only by the reflection plate 48 but also by the reflection layer 46, infrared radiation could be efficiently directed to a region on the opposite side to the reflection layer 46 and the temperature of the lower end of the second outer pipe increased slightly as a result.

Moreover, the temperature of the upper end of the second outer pipe 45 of Example 1 was lower than that of Example 2. It is considered that, because the reflection layer 46 was disposed on the surface of the first outer pipe 44 in Example 1, the amount of electromagnetic radiation that reached the second outer pipe 45 was reduced as compared with Example 2, in which the reflection layer 46 was disposed on the surface of the second outer pipe 45, and overheating of the second outer pipe 45 could be suppressed.

The present application claims priority from Japanese patent application No. 2012-245253 filed on Nov. 7, 2012, the entire contents of which are incorporated herein by reference.

What is claimed is:

1. An infrared heating apparatus used for a drying furnace, comprising:
a heating element that emits electromagnetic radiation including infrared radiation when heated;
an inner wall that transmits infrared radiation;
a reflection layer that is disposed outside of the inner wall and away from the inner wall when viewed from the heating element so as to cover only a part of a periphery of the heating element, the reflection layer reflecting infrared radiation;
a coolant channel that allows a coolant for cooling the reflection layer to flow therethrough; and
a transmission wall that is disposed between the inner wall and the reflection layer and that transmits infrared radiation,
wherein the reflection layer is disposed away from the transmission wall, and
at least one of the inner wall and the transmission wall absorbs a part of the electromagnetic radiation.

2. The infrared heating apparatus according to claim 1, further comprising:
a reflection plate that is disposed outside of the reflection layer when viewed from the heating element so as to cover only a part of the periphery of the heating element, the reflection plate reflecting infrared radiation.

3. The infrared heating apparatus according to claim 1, further comprising:
an outer wall that is disposed outside of the reflection layer and away from the reflection layer when viewed from the heating element,
wherein the coolant channel is formed inside of the outer wall when viewed from the heating element.

4. The infrared heating apparatus according to claim 1,
wherein the inner wall absorbs a part of the electromagnetic radiation.

5. A drying furnace comprising the infrared heating apparatus according to claim 1.
